(19) United States
(12) Patent Application Publication
(10) Pub. No.: US 2005/0014561 A1
(43) Pub. Date: Jan. 20, 2005

(54) Simulator, method of controlling simulator, program, and information storage medium

(75) Inventor: Satoru Ouchi, Yokohama-shi (JP)

Correspondence Address: OLIFF & BERRIDGE, PLC, P.O. BOX 19928, ALEXANDRIA, VA, 22320, US

(73) Assignee: NAMCO LTD., Tokyo (JP)

(21) Appl. No.: 10/828,304

(22) Filed: Apr. 21, 2004

(30) Foreign Application Priority Data
Apr. 25, 2003 (JP) 2003-121021

(51) Int. Cl. A63F 13/00

(52) U.S. Cl. 463/36

(57) ABSTRACT

The present invention relates to a simulator that enables vibration sensations that correspond to simulation contents or the operator's preferences. This simulator causes an operator to sense vibrations by driving a vibration mechanism in accordance with a generation of a given simulation state. This simulator includes: a simulation calculation section which performs a simulation calculation to manipulate a simulator object in accordance with an operational input from an operating section; a vibration mechanism control section which drives the vibration mechanism on condition that a predetermined vibration occurrence simulation state has occurred, by a simulation calculation; and a vibration condition setting section which receives a vibration condition setting which specifies the vibration occurrence simulation state, by an operational input from an operating section for vibration condition setting.

Japanese Patent Application No. 2003-121021, filed on Apr. 25, 2003, is hereby incorporated by reference in its entirety.

### BACKGROUND OF THE INVENTION

The present invention relates to a simulator, a method of controlling a simulator, a program, and an information storage medium.

With a simulator such as a car-driving simulator, it is known in the art to generate vibrations to match the current driving state and impart them to the driver, to enable the driver to experience a feeling as if driving in real life.

With a game simulator that plays an arcade game, it is known to generate vibrations to match the game environment, making it possible to give the player a game that is highly realistic. Such a simulator is known from Japanese Patent Laid-Open No. 9-84957, for example.

However, there is a problem with prior-art simulators in that, since the states in which vibrations occur are set previously by the programming, vibrations could occur even in states in which the operator of the simulator would prefer they do not occur.

Taking a simulator for driver training as an example, an operator who is a nervous beginner would often prefer that vibrations that cause unwanted noise do not occur. An operator who prefers a state that is close to real life would prefer vibrations to occur as they would in a real situation. With a prior-art simulator, however, this tailoring to respond to the requests of the operators is unheard of

### BRIEF SUMMARY OF THE INVENTION

The present invention was devised in the light of the above-described technical problems, and may provide a simulator, a method of controlling a simulator, a program, and an information storage medium that make it possible to modify the settings of vibration conditions that specify simulation states in which vibrations occur, in accordance with requests from the operator.

(1) To solve the above described problems, a simulator according to the present invention, which imparts vibrations to an operator by driving a vibration mechanism in accordance with a generation of a given simulation state, includes:

a simulation calculation section which performs a simulation calculation to manipulate a simulator object in accordance with an operational input from an object operating means;

a vibration mechanism control section which drives the vibration mechanism on condition that a predetermined vibration occurrence simulation state has occurred, by the simulation calculation; and

a vibration condition setting section which receives a vibration condition setting which specifies the vibration occurrence simulation state, by an operational input from an operating section for vibration condition setting,

wherein the vibration condition setting section performs condition setting processing to receive a setting of a vibration content which includes at least one of vibration intensity, a vibration pattern and vibration length of the vibration mechanism, in the vibration occurrence simulation state specified by the vibration condition setting, and

wherein the vibration mechanism control section drives the vibration mechanism relating to the set vibration content, when the vibration occurrence simulation state specified by the vibration condition setting occurs.

A method of controlling a simulator according to the present invention, which imparts vibrations to an operator by driving a vibration mechanism in accordance with a generation of a given simulation state, includes:

a simulation calculation step in which a simulation calculation is performed to manipulate a simulator object in accordance with an operational input from an object operating section;

a vibration mechanism control step in which the vibration mechanism is driven on condition that a predetermined vibration occurrence simulation state has occurred, by the simulation calculation; and

a vibration condition setting step in which a vibration condition setting, which specifies the vibration occurrence simulation state, is received by an operational input from an operating section for vibration condition setting,

wherein the vibration condition setting step includes performing condition setting processing to receive a setting of a vibration content which includes at least one of vibration intensity, a vibration pattern and vibration length of the vibration mechanism, in the vibration occurrence simulation state specified by the vibration condition setting, and

wherein the vibration mechanism control step includes performing processing to drive the vibration mechanism relating to the set vibration content when the vibration occurrence simulation state specified by the vibration condition setting occurs.

A program according to the present invention causes a computer to implement the above method.

In this case, the vibration mechanism imparts vibrations to the operator and can have a configuration in which a vibration motor is used therefor, by way of example. The vibration mechanism can be provided in various locations depending on the contents of the simulator calculations and the type of simulator. It could be provided close to a seat or various operational sections in a simulator in which the operator sits to perform the operations, by way of example. Or it could be provided within a controller manipulated by the player if this is a domestic game operated by controllers.

The simulator of the present invention refers to a wide range of devices that simulate various states, including various driving simulators, arcade game machines, and also domestic game machines, by way of example.

The vibration occurrence simulation state refers to a state that can implement more realistic states by imparting a vibration to the operator in the virtual space that is being simulated. For example, the simulator object to be operated hits an obstacle or travels along a gravel road in a driving simulator.

The setting of a vibration condition that specifies a vibration occurrence simulation state means to set a condition which specifies under what simulation state vibration occurs. If a plurality of vibration occurrence simulation states have been set by programming, for example, the operator can set a vibration condition as to whether or not vibration is to occur, for each of the plurality of states.

The vibration contents refers to the kind of vibration that occurs, such as details of the vibration intensity, vibration pattern, and vibration length, by way of example.

The simulator of the present invention enables the operator to manipulate a simulator object within a virtual space by manipulating an object operating section. If a vibration occurrence simulation state occurs during this time, the vibration mechanism control section drives the vibration mechanism to make the operator experience vibrations corresponding to that state, making it possible to implement a highly realistic simulation.

During this time, the simulator of the present invention makes it possible for the operator to use the operating section for vibration condition setting to set vibration conditions that specify simulation states in which vibrations occurs. This makes it possible for the operator to set vibration conditions such that vibrations occur only in states preferred by the operator, even when a plurality of vibration occurrence simulation states are provided by the programming, by way of example. In this manner, the present invention enables the operator to determine whether or not each simulation condition that would provide vibrations does produce vibration effects, making it possible to provide a simulator that produces highly effective vibration effects in accordance with the operator's preferences.

In particular, since the present invention makes it possible for the operator to set details of the vibrations that occur, such as vibration intensity, a vibration pattern, and vibration length, in addition to setting vibration conditions, it makes it possible to provide a simulator that can produce highly effective vibration effects that can be matched to the operator's preferences.

Note that if the simulator of the present invention is applied to a domestic game machine, the configuration could be such that this game machine includes a controller having the vibration mechanism, a main device of the domestic game machine and a display. In the main device of the domestic game machine is installed a program that causes the game machine to function as the above-described simulation calculation section, vibration mechanism control section and a vibration condition setting section (or is set a storage medium of the program). The domestic game console functions as the vibration mechanism control section and the vibration condition setting section to control the vibration mechanism of the controller.

(2) With a playing machine, program, and information storage medium according to the present invention, the vibration condition setting section may be formed to perform condition setting processing to display a vibration condition setting image on a display and receive the vibration condition setting by an operation input from the operating section for vibration condition setting to store in a storage section.

In this case, the storage section could be provided within the simulator, or it could be provided in an external device connected by a network or the like, or the operator could use an external storage medium that can be freely transported.

(3) With a playing machine, program, and information storage medium according to the present invention, the vibration mechanism control section may be formed to synthesize a plurality of the vibration contents that have been set by the vibration content setting section and control the vibration mechanism when a plurality of the simulation states occur simultaneously as conditions that cause the vibration mechanism to vibrate.

(4) With a playing machine, program, and information storage medium according to the present invention, the vibration mechanism control section may be formed to control the vibration mechanism in accordance with degrees of priority assigned to the simulation states when a plurality of the simulation states occur simultaneously as conditions that cause the vibration mechanism to vibrate.

### BRIEF DESCRIPTION OF THE SEVERAL VIEWS OF THE DRAWING

FIG. 1 shows a block diagram of a game system in accordance with an embodiment of the present invention.

FIGS. 2A to 2C are illustrative of menu images for setting details of the vibration of each vibration occurrence component.

FIG. 3 is a flowchart of an example of the processing that inputs vibration condition settings for each vibration occurrence component.

FIG. 4 is a flowchart of an example of the processing for vibration control.

FIG. 5 is a flowchart of an example of the processing for vibration control.

FIG. 6 shows an example of a hardware configuration that can implement an embodiment of the present invention.

FIG. 7A to 7C show examples of various different systems to which an embodiment of the present invention is applied.

### DETAILED DESCRIPTION OF THE EMBODIMENT

Embodiments of the present invention will be described below. Note that the embodiments described hereunder do not in any way limit the scope of the invention defined by the claims laid out herein. Note also that all of the elements of these embodiments should not be taken as essential requirements to the present invention. The embodiments of the present invention are described below with reference to the drawings.

1. Simulator Configuration

A preferred embodiment of a simulator to which the present invention is applied is described below.

Note that the embodiments described hereunder do not in any way limit the scope of the invention defined by the claims laid out herein. Note also that all of the elements of these embodiments should not be taken as essential requirements to the means of the present invention.

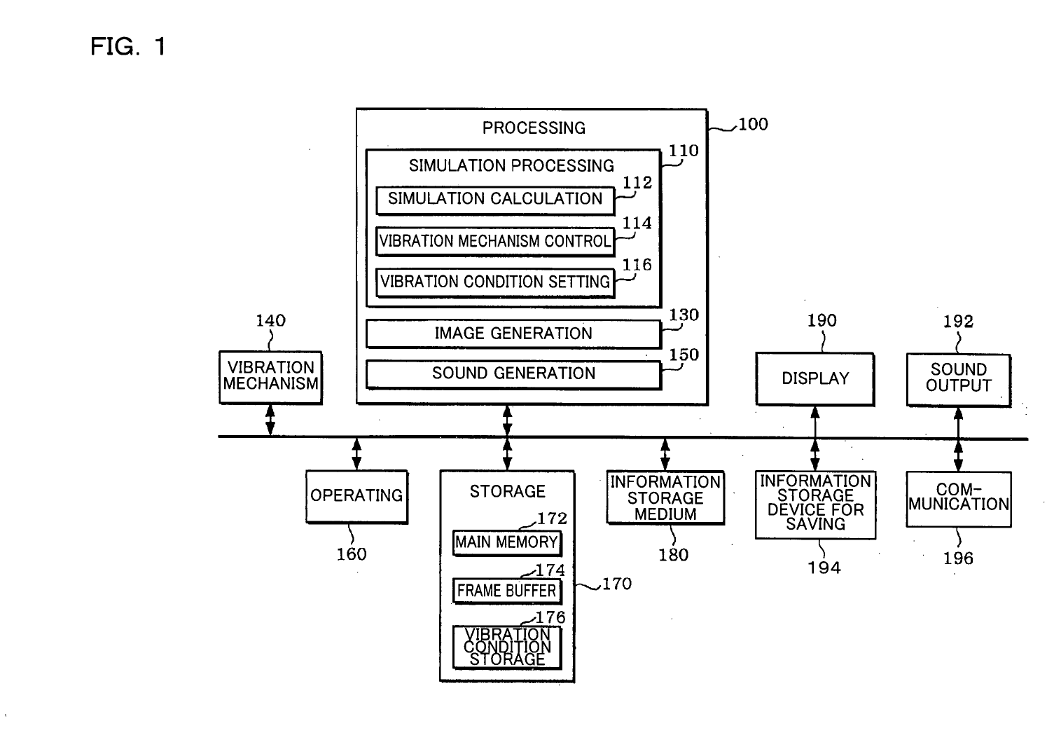

A typical block diagram of this embodiment is shown in FIG. 1. Note that the embodiment shown in this figure could include at least a processing section 100 and all other blocks therein can be assumed to be arbitrary configurational elements.

This processing section 100 performs various types of processing, such as control over the entire system, indication of commands to the blocks within the system, simulation processing, image processing, and sound processing. The functions thereof can be implemented by hardware such as various different processors (such as a CPU or DSP) or an ASIC (gate array), or by a given program (simulation program).

An operating section 160 is designed to enable an player to input operating data, where the functions thereof can be implemented by hardware such as levers, buttons, or a casing.

A vibration mechanism 140 is designed to generate vibrations corresponding to simulation states of the simulator, where the functions thereof can be implemented by vibration motors, by way of example.

A storage section 170 acts as a work area for components such as the processing section 100 and the communication section 196, so it functions as a main memory 172, a frame buffer 174, and a vibration condition storage section 176, and it can be implemented by hardware such as RAM.

An information storage medium 180 (a storage medium that can be read by a computer) is designed to store information such as programs and data, where the functions thereof could be implemented by hardware such as an optical disk (CD or DVD), a magneto-optical (MO) disk, a magnetic disk, a hard disk, magnetic tape, or ROM. The processing section 100 performs the various types of processing in accordance with this embodiment, based on the information stored in this information storage medium 180. In other words, within the information storage medium 180 is stored information (a program or data) for causing the implementation of the processing of the present invention (this embodiment), particularly that of the blocks included within the processing section 100.

Note that some or all of the information stored in the information storage medium 180 could be transferred to the storage section 170 at suitable timing, such as when the system power is turned on. The information stored in the information storage medium 180 includes at least one type of information, such as program coding for executing the processing in accordance with this embodiment, image data, sound data, shape data for display objects, table data, list data, information for instructing processing in accordance with the present invention, or information for performing processing in accordance with such instructions.

A display section 190 is designed to output images generated by this embodiment of the present invention, and the functions thereof can be implemented by hardware such as a CRT, LCD panel, touch-panel, or head-mounted display (HMD).

A sound output section 192 is designed to output sounds created by this embodiment, and the functions thereof can be implemented by hardware such as a speaker or headphones.

An information storage device 194 for saving stores data such as a player's personal data (saved data), and various devices such as a memory card or a portable simulation device could be conceived as this information storage device 194 for saving.

The communication section 196 is designed to provide various types of control for communicating with an external device (such as a host device or another image generation system), and the functions thereof can be implemented by hardware such as various types of processor or a communication ASIC, or by a program.

Note that a program or data for causing the implementation of the various processes of the present invention (this embodiment) on a computer could be distributed to the information storage medium 180 from an information storage medium possessed by a host device (server), through a network and the communication section 196. Such use of an information storage medium on the host device (server) is also included within the scope of the present invention.

The processing section 100 includes a simulation processing section 110, an image generation section 130, and a sound generation section 150.

The simulation processing section 110 executes the simulation processing for the game in accordance with this embodiment.

In other words, this simulation processing section 110 executes various types of simulation processing, based on operating data from the operating section 160, personal data from the information storage device 194 for saving, or a simulation program, including: processing for accepting a coin (or equivalent), processing for setting various modes, processing for moving the simulation forward, processing for setting selection images, processing for obtaining the position and rotational angle (about the X, Y, or Z axis) of an object (one or a plurality of primitive surfaces), processing for causing an object to move (motion processing), processing for obtaining the position of a viewpoint (position of a virtual camera) and the angle-of-view thereof (rotational angle of the virtual camera), processing for disposing objects such as map objects in an object space, hit-check processing, processing for calculating simulation results (achievements and score), processing for enabling a plurality of players to play in a common game space, and game-over processing.

The simulation processing section 110 includes a simulation calculation section 112, a vibration mechanism control section 114, and a vibration condition setting section 116.

The simulation calculation section 112 performs simulation calculations for the game in which a game object is manipulated, in accordance with operational inputs from the operating section 160 that functions as an object operating section.

The vibration mechanism control section 114 performs processing to drive the vibration mechanism 140 on condition that these simulation calculations have determined that a vibration occurrence simulation state has occurred, thus allowing the player to feel vibrations that are suited to that simulation state.

The vibration condition setting section 116 performs processing for accepting a vibration condition setting that specifies the vibration occurrence simulation state, in accordance with an operational input from an operating section for specifying the vibration condition. In this embodiment, the operating section 160 functions as the operating section for vibration condition setting, and the thus-set vibration condition is written into the vibration condition storage section 176 of the storage section 170. Note that the configuration could be such that the thus-set vibration condition is also written in a readable manner into the information storage device 194 for saving, if necessary. In addition, a configuration could also be used in which the thus-set vibration condition is written in a readable manner into memory of the host device through a communication circuit, if necessary.

The image generation section 130 performs various types of image processing such as geometry processing (three-dimensional calculations) including coordinate conversion, clipping processing, transparency conversion, or light source calculations, or drawing processing for drawing an object (model) after such geometry processing into a frame buffer, in accordance with instructions from the simulation processing section 110 or the like, to generate an image as seen from a virtual camera (viewpoint) within an object space for output to the display section 190.

The sound generation section 150 performs various types of sound processing in accordance with instructions from the simulation processing section 110 or the like, to generate game sounds such as background music, sound effects, and voices for output to the sound output section 192.

Note that the functions of the simulation processing section 110, the image generation section 130, and the sound generation section 150 could all be implemented by hardware, or they could all be implemented by programming. Alternatively, they could be implemented by both hardware and programming.

Note also that the simulation system of this embodiment could be applied to a system with a dedicated single-player mode, which enables one player to play the game, or it could also be applied to a system provided with a multi-player mode, which enables a plurality of players to play.

If a plurality of players are playing, the game images and game sounds supplied to this plurality of players could be created by using one terminal, or they could be created by using a plurality of terminals connected by a network (transmission lines or communication circuitry) or the like.

2. Characteristics of This Embodiment

The description now turns to the characteristics of this embodiment, with reference to the accompanying figures.

The characteristic configuration of this embodiment is described below as an example of the application to an arcade game device that provides a driving game in the simulator of this embodiment.

In the simulator of this embodiment, a player who is the operator manipulates the operating section 160 to control his or her own virtual racing car (hereinafter called “own racing car”), which is a simulator object, to play the game. The simulation calculation section 112 calculates a virtual three-dimensional game space for a driving game, based on inputs from the operating section 160 and a given program; the image generation section 130 generates a game image in which the player's own racing car runs on a course, and displays it on the display section 190; and the sound generation section 150 generates game sound effects for output to the sound output section 192.

During this time, the vibration mechanism control section 114 drives the vibration mechanism 140 on condition that a vibration occurrence simulation state has occurred, as dictated by the simulation calculations. Thus the player can be made to feel vibrations that match the game state calculated by the simulation, making it possible to impart reality to the game and also boost that environment.

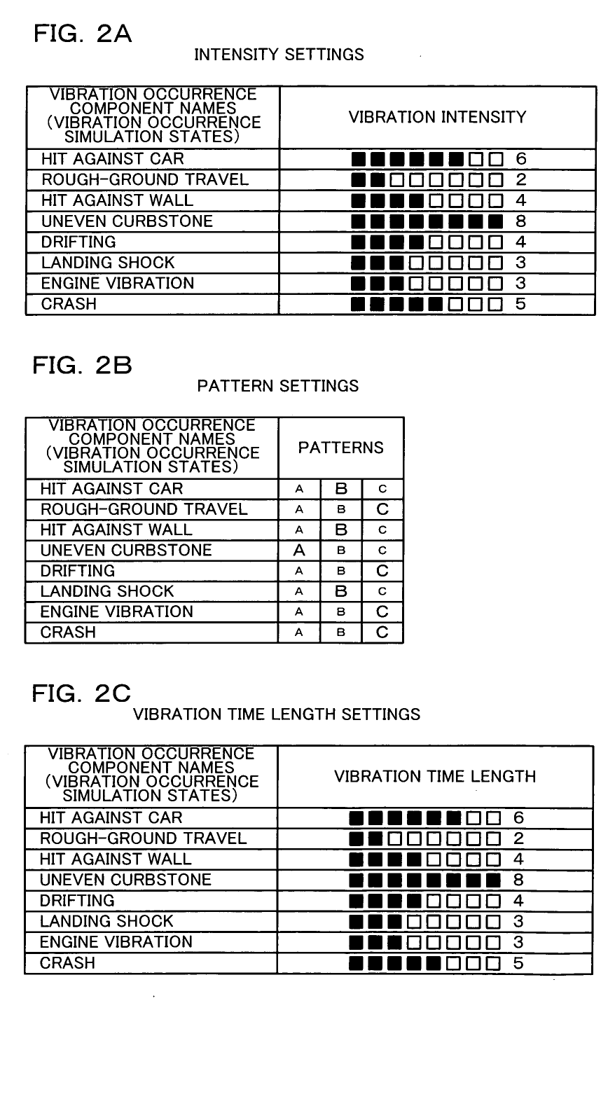

Specific examples of vibration occurrence simulation states in which vibrations occur are shown in FIG. 2A as “vibration occurrence component names” determined by these simulation calculations, with nine levels of vibration intensity from 0 to 8.

The relationship between each vibration occurrence component and corresponding vibration patterns is shown in FIG. 2B, with vibration patterns A, B, and C being selectable for each vibration occurrence component. In this figure, the patterns denoted by large letters are the currently selected patterns.

The relationship between each vibration occurrence component and corresponding vibration occurrence times is shown in FIG. 2C, with a vibration occurrence time of between 1 second and 8 seconds being selectable for each vibration occurrence component.

In this manner, the simulator of this embodiment (in other words, a simulator that provides a driving game) has a configuration that enables the player (who is the operator) to select vibration intensity, vibration pattern, and vibration length for each of at least eight different vibration occurrence components as shown in FIG. 2.

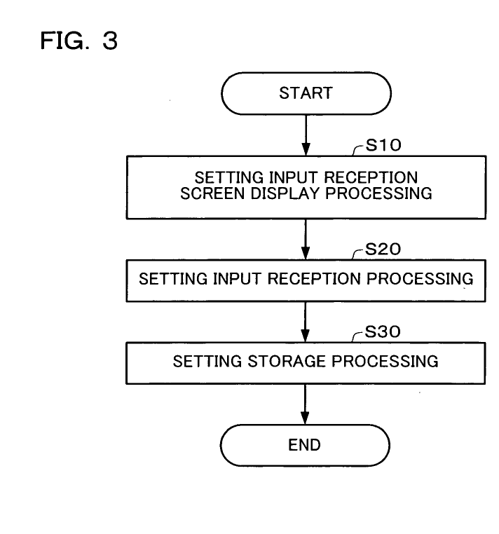

A flowchart of the sequence of processing that enables the player to set the vibration occurrence condition and vibration occurrence pattern is shown in FIG. 3.

First of all, the player operates the operating section 160 to cause a menu selection image (not shown in the figure) to appear on the display section 190, and selects a vibration condition setting input reception mode therefrom.

When that happens, the vibration mechanism setting section 114 displays the setting input reception images shown in FIGS. 2A to 2C on the display section 190 in step S10, then starts setting input reception processing in step S20.

The player sets vibrations contents (specifically, the vibration intensity, pattern, and continuation time) for each vibration occurrence component (vibration occurrence simulation state) while viewing the images of FIG. 2.

Default values that are set previously by the programming are displayed on the setting input reception images of FIGS. 2A to 2C. If the player does not change these default values, the vibration occurrence control is performed in accordance with the default values shown in FIG. 2.

The settings of whether or not vibration should occur for each vibration occurrence component, and the intensity thereof if it is set to occur, are input by using the menu image shown in FIG. 2A. The vibration intensity can be set to zero for a vibration occurrence component that the player does not wish to occur.

Three vibration patterns, A, B, and C, are provided for each vibration occurrence component, as shown in FIG. 2B. The player can select any desired vibration pattern from those three patterns.

Vibration lengths of between one second and eight seconds are provided for each vibration occurrence component, as shown in FIG. 2C, enabling the player to set any desired vibration length therefor.

Once the player has used the operating section 160 to set whether or not vibrations are to occur and the vibration contents thereof, for each vibration occurrence component, and also used the operating section 160 to confirm the contents of those settings, setting storage processing is done in the next step S30 to update the data that has been set in the vibration condition storage section 176.

This sequence of processing shown in FIG. 3 could be done before the player starts the game, or it could be done during the game by the display of a suitable menu image.

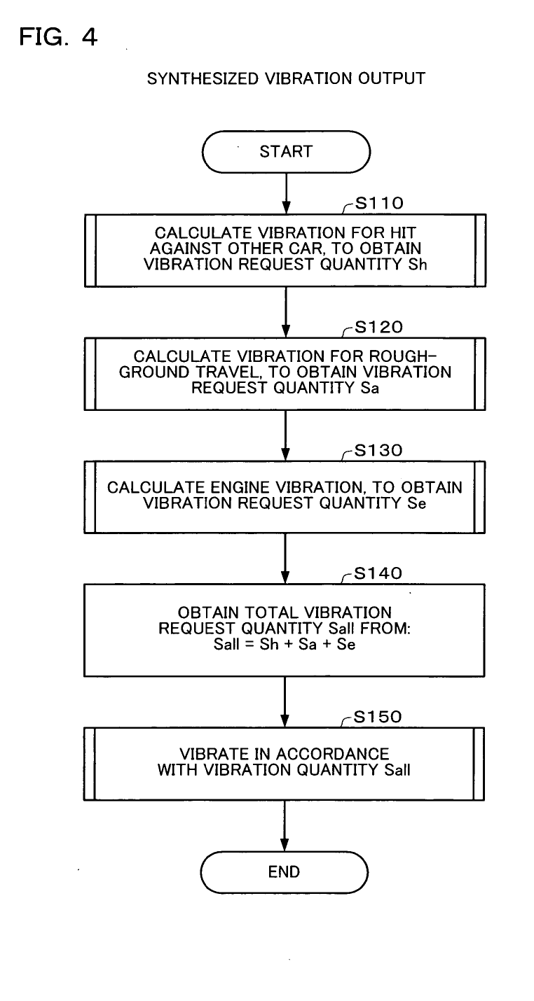

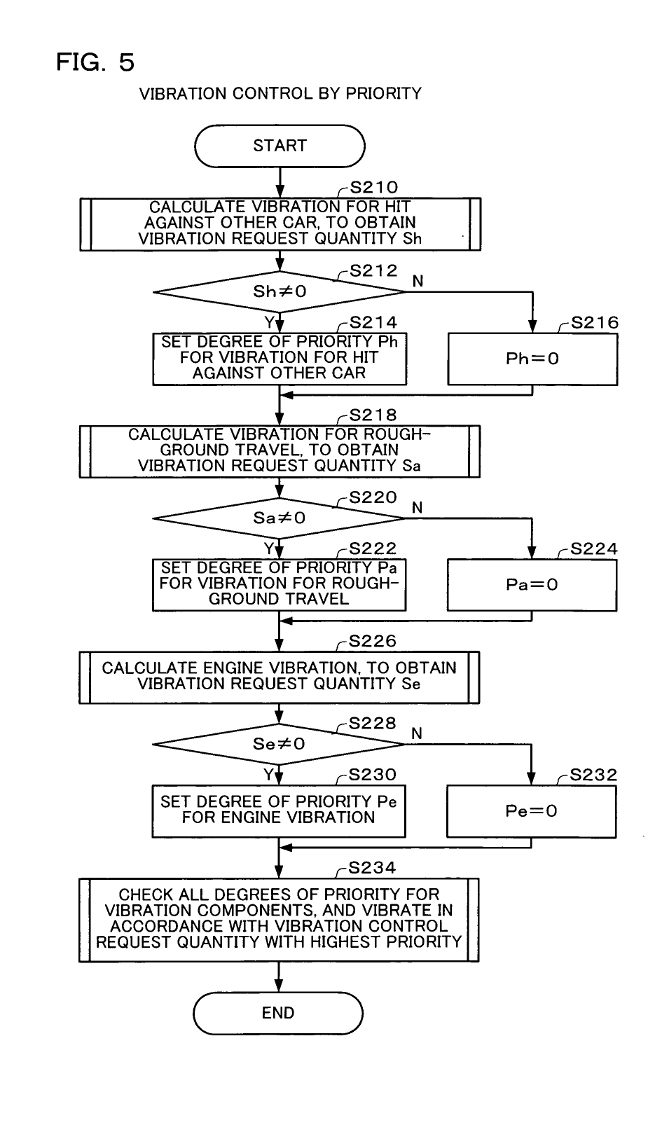

Flowcharts shown in FIGS. 4 and 5 show examples of the control of the vibration mechanism 140 that is performed by the vibration mechanism control section 114 in accordance with the setting conditions that have been stored in the vibration condition storage section 176 as described above.

When a vibration occurrence simulation state (vibration occurrence component) occurs as specified by the vibration control settings, in accordance with the simulation calculations of the simulation calculation section 112, the vibration mechanism control section 114 drives the vibration mechanism 140 in accordance with the thus-set vibration contents. In other words, it drives the vibration mechanism 140 in accordance with the thus-set vibration intensity, pattern, and length.

This ensure that, whenever a predetermined vibration occurrence simulation state occurs during the game, the player can enjoy the game while experiencing vibrations conforming to the vibration contents that have been set to suit the player's preferences.

The vibration occurrence control processing of FIG. 4 will first be described.

The description in this case relates to an example in which the vibrations for simultaneously occurring simulation states are “hit against car” in which the player's own car hits another car, leading to “rough-ground travel” in which the player's car leaves the course and travels over rough ground, and “engine vibration”.

First of all, in step S110, the system performs processing to calculate the vibration for a hit against another car to obtain a vibration request value Sh.

In the next step S120, the system performs processing to calculate the vibration for rough-ground travel to obtain a vibration request quantity Sa.

In step S130, the system then calculates engine vibrations to obtain a vibration request quantity Se.

In step S140, the system adds the thus-obtained request quantities to obtain a total vibration request quantity Sall by the following equation:
Sall=Sh+Sa+Se

In step S150, the vibration mechanism control section 114 controls the driving of the vibration mechanism 140 in such a manner as to achieve the thus-obtained total vibration request quantity Sall.

Thus, even if a plurality of vibration occurrence component occur simultaneously, this configuration makes it possible to generate vibrations by synthesizing those components, to enable the player to feel those vibrations.

The description now turns to the vibration occurrence control processing of FIG. 5.

In this case, a priority is set for each vibration occurrence component, and the type of vibration with the highest priority is executed selectively when a plurality of vibration occurrence simulation state occurs simultaneously. The description below also assumes that the three types of vibration occur: “hit against car”, “rough-ground travel”, and “engine vibration”

First of all, in step S210, the system performs processing to calculate the vibration caused by a hit against another car, to obtain the vibration request quantity Sh.

In step S212, the system determines whether or not the request quantity obtained by the calculations is 0. If it is 0, it sets a corresponding degree of priority Ph to 0 in step S216. If it is not 0, a degree of priority Ph for vibration for the hit against the other car is set in step S214 based on a previously prepared program.

In step S218, the system performs processing to calculate the vibration for rough-ground travel, to obtain the vibration request quantity Sa.

The system then determines whether or not the thus-obtained value Sa is 0 in step S220. If it is 0, it sets a degree of priority Pa for that request quantity to 0 in step S224. If it is determined that the thus-obtained value Sa is not 0, the system performs processing in step S222 for setting the degree of priority Pa for rough-ground travel vibration, in accordance with a previously prepared program.

In step S226, the system performs processing to calculate engine vibration to obtain the corresponding vibration request quantity Se, then determines whether or not that request quantity Se is 0 in the next step S228. If it is 0, the system sets a corresponding degree of priority Pe to 0. If it is not 0, the system preforms processing for setting the degree of priority Pe in step S230.

After this sequence of processes ends, the system checks all of the degrees of priority of these vibration occurrence components, then controls the driving of the vibration mechanism 140 based on the vibration request quantity of the vibration occurrence component that has the highest degree of priority in step S234.

In this manner, the vibration with the highest degree of priority is executed selectively when a plurality of vibration occurrence simulation states occurs simultaneously.

Note that the configuration of this embodiment could be such that the user sets each of the vibration control of FIG. 4 and the vibration control of FIG. 5 individually, or one of them could be executed by a program, or selective output of vibrations based on the synthesized vibration output of FIG. 4 and the degree of priority of FIG. 5 could be done by a program in accordance with the state.

In any of these cases, this embodiment makes it possible to control the vibration mechanism 140 to produce vibrations with conditions and contents as set by the player, even when a predetermined vibration occurrence simulation state occurs during the game, so that the player can enjoy experiencing a highly realistic simulation game.

In prior-art game devices in particular, the player is not able to set vibrations corresponding to each vibration occurrence component, but this embodiment makes it possible to implement a simulation in which vibration conditions and contents are set to reflect the wishes of the player for each vibration occurrence component, so that the player can be made to feel the vibrations linked thereto.

3. Hardware Configuration

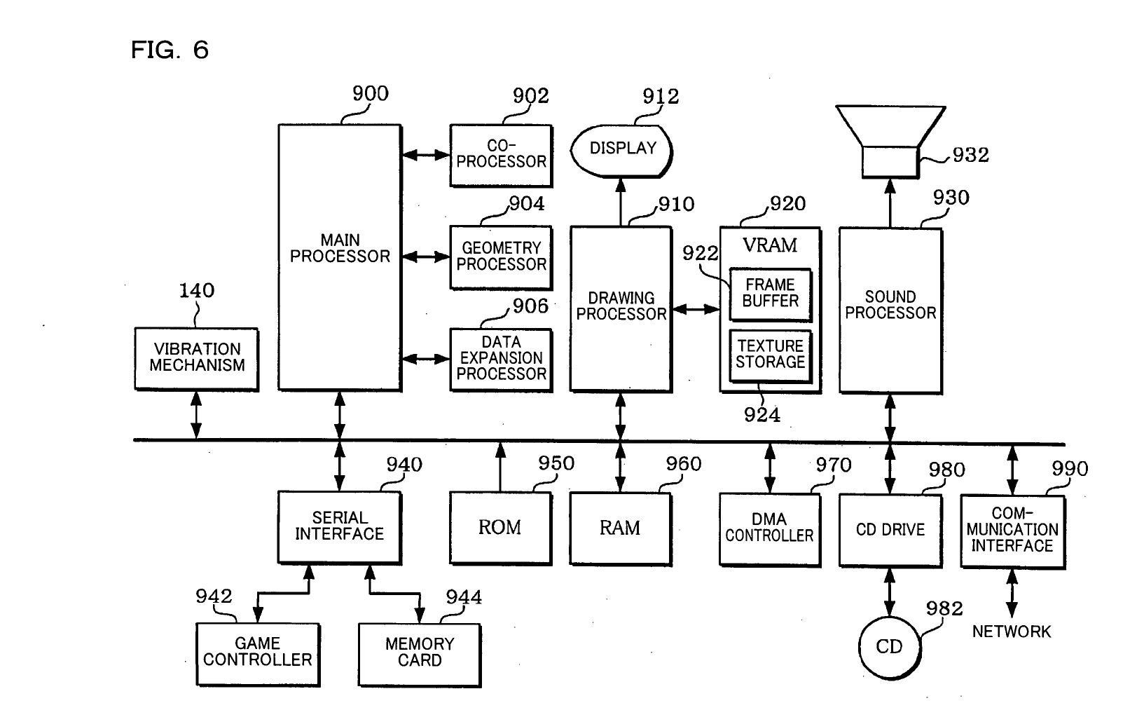

The description now turns to an example of a hardware configuration that can implement this embodiment of the present invention, with reference to FIG. 6.

A main processor 900 operates in accordance with a program stored in a CD 982 (an information storage medium), a program transferred through a communication interface 990, or a program stored in a ROM 950 (an information storage medium), to perform various different types of processing such as game processing, image processing, and sound processing.

The main processor 900 also executes vibration control processing and vibration condition setting processing for the vibration mechanism 140.

A co-processor 902 is designed to supplement the processing of the main processor 900, and it includes product-summers and dividers that enable high-speed parallel computations, to execute matrix computations (vector computations) at high speed. When matrix computations or the like are necessary in a physical simulation for making an object move and act, by way of example, a program running on the main processor 900 will instruct (request) the co-processor 902 to perform that processing.

A geometry processor 904 is designed to perform geometrical processing such as coordinate conversion, transparency conversion, light-source computation, and curved surface generation, and it includes product-summers and dividers that enable high-speed parallel computations, to execute matrix computations (vector computations) at high speed. When processing such as coordinate conversion, transparency conversion, or light-source computation is performed, by way of example, a program running on the main processor 900 will instruct the geometry processor 904 to perform that processing.

A data expansion processor 906 performs decoding to expand compressed image and sound data, and also performs processing to accelerate the decoding of the main processor 900. This ensures that moving images that have been compressed by the MPEG method or the like can be displayed during an opening image, intermission image, ending image, or game images. Note that the image and sound data to be decoded is stored in the ROM 950 or the CD 982, or it is transferred from the exterior through the communication interface 990.

The drawing processor 910 is designed to draw (render) an object made up of primitive surfaces such as polygons or curved surfaces, at high speed. During the drawing of the object, the main processor 900 utilizes the functions of a DMA controller 970 to pass object data to the drawing processor 910 and also transfer textures in a texture storage section 924, if necessary. When that happens, the drawing processor 910 renders the object into a frame buffer 922 at high speed, based on this object data and textures, while utilizing a Z buffer or the like to erase hidden surfaces.

The drawing processor 910 can also perform processing such as an alpha-blending (translucency processing), depth queuing, mip mapping, fog processing, bilinear filtering, trilinear filtering, anti-aliasing, and shading. When images for one frame are written to the frame buffer 922, those images are displayed on a display 912.

A sound processor 930 incorporates a multi-channel ADPCM audio source or the like and generates high-quality game sounds such as background music, sound effects, and voices. The thus-created game sounds are output from a speaker 932.

Manipulation data from a simulation controller 942 and save data and personal data from a memory card 944 are transferred through a serial interface 940.

A system program or the like is stored in the ROM 950. Note that if the system is an arcade game system, the ROM 950 would function as an information storage medium and various different programs would be stored in the ROM 950. Note also that a hard disk could be utilized instead of the ROM 950

A RAM 960 is used as a work area for the various processors.

The DMA controller 970 controls DMA transfer between the processors and memory (such as RAM, VRAM, or ROM).

A CD drive 980 drives the CD 982 (information storage medium) which contains data such as a program, image data, and sound data, enabling access to that program and data.

The communication interface 990 provides an interface for data transfer to and from external devices over a network. In this case, a communication circuit (analog telephone line or ISDN) or high-speed serial interface bus could be considered as the network connected to the communication interface 990. The use of a communication circuit would make it possible to transfer data over the Internet. The use of a high-speed serial interface bus would also make it possible to transfer data to and from other devices such as another game system.

Note that the various components of the present invention could all be implemented by hardware alone or they could be implemented just by a program stored in an information storage medium or a program distributed through a communication interface. Alternatively, they could be implemented by both hardware and programming.

If the various components of the present invention are implemented by both hardware and a program, a program for implementing the components of the present invention in hardware is stored in the information storage medium. More specifically, this program instructs the processors 902, 904, 906, 910, and 930, which are hardware, and also transfers data if necessary. The processors 902, 904, 906, 910, and 930 implement the various components in accordance with the present invention, based on these instructions and the transferred data. In other words, they function as the components shown in FIG. 1 and also execute the various processes shown in FIGS. 2 to 5, such as simulation calculation processing, vibration mechanism control processing, vibration condition setting processing, and image generation processing.

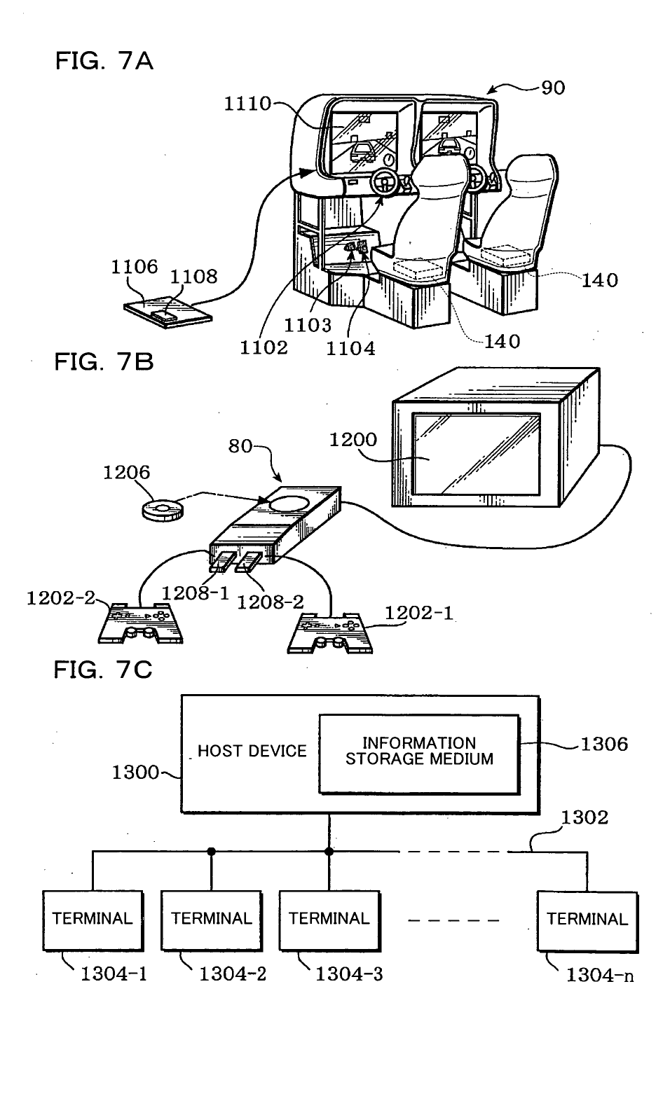

An example of this embodiment applied to an arcade game system is shown in FIG. 7A. Each player enjoys this game by operating controls such as a steering wheel 1102, accelerator 1103, and brake 1104 while viewing a game image shown on a display 1100. Components such as the various processors and memory units are mounted on a system board (circuit board) 1106. A program (or program and data) for implementing the means of the present invention is stored in memory 1108 that is an information storage medium on the system board 1106. This information is hereinafter called stored information.

In this arcade game system, the vibration mechanism 140 that enables each player to feel vibrations is provided within each seat on which the players sit, the vibration conditions and contents for the vibration mechanism 140 are set on the basis of the processing described with reference to FIGS. 2 to 5, and that vibration control is executed.

This makes it possible to provide a game system that enables the player to feel vibrations that are finely tuned to the player's requests to correspond to the game state.

An example of this embodiment of the invention applied to a domestic game machine is shown in FIG. 7B.

This game system is configured of a main game device 80 for domestic use, a CD 1206 or memory cards 1208-1 and 1208-2 that are storage media that can be freely inserted into and removed from the main game device 80, a display 1200 connected to the main game device 80, and two controllers 1202-1 and 1202-2 connected to the main game device 80.

Players enjoy the game by manipulating the controllers 1202-1 and 1202-2 while viewing a game image shown on the display 1200. In this case, the above-described stored information is stored in the CD 1206 or the memory cards 1208-1 and 1208-2 that can be freely inserted into and removed from the main system.

In this case, the controllers 1202-1 and 1202-2 each function as the operating section 160 of FIG. 1, the display 1200 functions as the display section 190, the CD 1206 functions as the information storage medium 180, and the main game device 80 in which the CD 1206 is accommodated functions as the processing section 100, the storage section 170, the communication section 196, and other components shown in FIG. 1.

In addition, the vibration mechanism 140 of FIG. 1 is provided within each the controllers 1202-1 and 1202-2 of this domestic game system, and a vibration motor or the like is provided as the vibration mechanism 140.

When the players are operating the controllers 1202-1 and 1202-2 to play the game and a game simulation state as calculated by the main game device 80 occurs, such as the vibration occurrence simulation state shown in FIG. 2, the vibration mechanism 140 installed in each controller 1202 performs vibrations in accordance with the thus-set vibration intensity, pattern, and timing, enabling each player to experience vibrations corresponding to that game state.

In particular, since the present invention enables vibration control that reflects the wishes of each player, based on the vibration conditions and contents set by that player, it makes it possible for the player to enjoy the simulation game while experiencing more finely-tuned vibrations.

An example of this embodiment applied to a game machine is shown in FIG. 7C, where the game machine includes a host device 1300 and terminals 1304-1 to 1304-n that are connected to the host device 1300 by a network 1302 (a small-area network such as a LAN or a large-area network such as the Internet). In this case, the above described stored information is stored in an information storage medium 1306 such as a magnetic disk device, magnetic tape device, or memory that can be controlled by the host device 1300. If game images and sounds can be generated by each of the terminals 1304-1 to 1304-n in a stand-alone manner, means such as a game program for generating game images and sounds is transferred to the terminals 1304-1 to 1304-n from the host device 1300. If game images and sounds cannot be generated in a stand-alone manner by the terminals 1304-1 to 1304-n, on the other hand, the host device 1300 creates them then transfers them to those terminals for output thereby.

Note that the various components of the present invention in the configuration shown in FIG. 7C could also be divided between the host device (server) and the terminals. Similarly, the above described stored information used for implementing the present invention could be divided between an information storage medium on the host device (server) and information storage media of the terminals.

In addition, the terminals connected by the network could be either those of domestic game systems or those of arcade game systems. If arcade game systems are connected by a network, it is preferable to use portable information storage devices (memory cards or hand-held game machines) for saving that can exchange information with the arcade game systems and also exchange information with domestic game systems.

Note that the configuration could be such that the vibration mechanism 140 of FIG. 1 is provided within each terminal connected to the network, even with the embodiment of FIG. 7C, to enable control similar to that of each embodiment.

Note also that the present invention is not limited to the embodiment described above, and thus it can be modified in various ways.

For example, part of requirements of any claim of the present invention could be omitted from a dependent claim which depends on that claim. Moreover, part of requirements of any independent claim of the present invention could be made to depend on any other independent claim.

In addition, the simulator of the present invention was described by this embodiment as relating to an example in which it is used in a game, but the present invention is not limited thereto and thus it can be used in a wide range of other simulators such as a simulator for driving practice.

Similarly, the situation simulated by the simulator is not limited to the previously described driving, and thus the present invention can be applied to various other types of simulation such as action games or role-playing games.

The present invention can be applied to various game systems such as arcade game systems, domestic game systems, large-scale attractions in which many players can participate, simulators, multimedia terminals, and system boards that create game images.

1. A simulator which imparts vibrations to an operator by driving a vibration mechanism in accordance with a generation of a given simulation state, the simulator comprising:
a simulation calculation section which performs a simulation calculation to manipulate a simulator object in accordance with an operational input from an object operating section;
a vibration mechanism control section which drives the vibration mechanism on condition that a predetermined vibration occurrence simulation state has occurred; and
a vibration condition setting section which receives a vibration condition setting which specifies the vibration occurrence simulation state, by an operational input from an operating section for vibration condition setting,
wherein the vibration condition setting section performs condition setting processing to receive a setting of a vibration content which includes at least one of vibration intensity, a vibration pattern and vibration length of the vibration mechanism, in the vibration occurrence simulation state specified by the vibration condition setting, and
wherein the vibration mechanism control section drives the vibration mechanism relating to the set vibration content, when the vibration occurrence simulation state specified by the vibration condition setting occurs.

2. The simulator as defined by claim 1,
wherein the vibration condition setting section performs condition setting processing to display a vibration condition setting image on a display and receive the vibration condition setting by an operation input from the operating section for vibration condition setting to store in a storage section.

3. The simulator as defined by claim 1,
wherein when a plurality of the vibration occurrence simulation states occur simultaneously as conditions that cause the vibration mechanism to vibrate, the vibration mechanism control section synthesizes a plurality of the vibration contents that have been set by the vibration content setting section and controls the vibration mechanism.

4. The simulator as defined by claim 2,
wherein when a plurality of the vibration occurrence simulation states occur simultaneously as conditions that cause the vibration mechanism to vibrate, the vibration mechanism control section synthesizes a plurality of the vibration contents that have been set by the vibration content setting section and controls the vibration mechanism.

5. The simulator as defined by claim 1,
wherein when a plurality of the vibration occurrence simulation states occur simultaneously as conditions that cause the vibration mechanism to vibrate, the vibration mechanism control section controls the vibration mechanism in accordance with degrees of priority assigned to the simulation states.

6. The simulator as defined by claim 2,
wherein when a plurality of the vibration occurrence simulation states occur simultaneously as conditions that cause the vibration mechanism to vibrate, the vibration mechanism control section controls the vibration mechanism in accordance with degrees of priority assigned to the simulation states.

7. The simulator as defined by claim 3,
wherein when a plurality of the vibration occurrence simulation states occur simultaneously as conditions that cause the vibration mechanism to vibrate, the vibration mechanism control section controls the vibration mechanism in accordance with degrees of priority assigned to the simulation states.

8. A method of controlling a simulator which imparts vibrations to an operator by driving a vibration mechanism in accordance with a generation of a given simulation state, the method comprising:
performing a simulation calculation to manipulate a simulator object in accordance with an operational input from an object operating section;
driving the vibration mechanism on condition that a predetermined vibration occurrence simulation state has occurred; and
receiving a vibration condition setting, which specifies the vibration occurrence simulation state, by an operational input from an operating section for vibration condition setting,
wherein when receiving the vibration condition setting, which specifies the vibration occurrence simulation state, condition setting processing is performed to receive a setting of a vibration content which includes at least one of vibration intensity, a vibration pattern and vibration length of the vibration mechanism, in the vibration occurrence simulation state specified by the vibration condition setting, and
wherein when driving the vibration mechanism on condition that the vibration occurrence simulation state has occurred, processing to drive the vibration mechanism is performed relating to the set vibration content when the vibration occurrence simulation state specified by the vibration condition setting occurs.

9. The method of controlling a simulator as defined in claim 8, further comprising:
performing condition setting processing to display a vibration condition setting image on a display and receive the vibration condition setting by an operation input from the operating section for vibration condition setting to store in a storage section when receiving the vibration condition setting, which specifies the vibration occurrence simulation state.

10. The method of controlling a simulator as defined in claim 8, further comprising:
synthesizing a plurality of the vibration contents that have been set and controlling the vibration mechanism when a plurality of the simulation states occur simultaneously as conditions that cause the vibration mechanism to vibrate, at the time of driving the vibration mechanism on condition that the vibration occurrence simulation state has occurred.

11. The method of controlling a simulator as defined in claim 9, further comprising:
a plurality of the vibration contents that have been set when a plurality of the simulation states occur simultaneously as conditions that cause the vibration mechanism to vibrate, at the time of driving the vibration mechanism on condition that the vibration occurrence simulation state has occurred.

12. The method of controlling a simulator as defined in claim 8, further comprising:
controlling the vibration mechanism in accordance with degrees of priority assigned to the simulation states when a plurality of the simulation states occur simultaneously as conditions that cause the vibration mechanism to vibrate, at the time of driving the vibration mechanism on condition that the vibration occurrence simulation stat has occurred.

13. The method of controlling a simulator as defined in claim 9, further comprising:
controlling the vibration mechanism in accordance with degrees of priority assigned to the simulation states when a plurality of the simulation states occur simultaneously as conditions that cause the vibration mechanism to vibrate, at the time of driving the vibration mechanism on condition that the vibration occurrence simulation state has occurred.

14. The method of controlling a simulator as defined in claim 10, further comprising
controlling the vibration mechanism in accordance with degrees of priority assigned to the simulation states when a plurality of the simulation states occur simultaneously as conditions that cause the vibration mechanism to vibrate, at the time of driving the vibration mechanism on condition that the vibration occurrence simulation state has occurred.

15. A program for implementing the method as defined by claim 8.

16. A program for implementing the method as defined by claim 9.

17. A computer-readable information storage medium which stores the program defined by claim 15.
